(19) United States
(12) Patent Application Publication
(10) Pub. No.: US 2007/0230626 A1
(43) Pub. Date: Oct. 4, 2007

(54) WIRELESS RECEIVER

(76) Inventor: Koji TSUCHIE, Fujisawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/691,707

(22) Filed: Mar. 27, 2007

(30) Foreign Application Priority Data
Mar. 28, 2006 (JP) 2006-087707

(51) Int. Cl. H04L 27/22; H04L 25/06

(52) U.S. Cl. 375/332; 375/317

(57) ABSTRACT

A wireless receiver includes an AD converter which includes a plurality of units for converting a received analog signal into a digital signal and can switch an output precision by selecting one or more units to be operated from the plurality of units, and a received signal level calculator which is connected to the AD converter and calculates a received signal level based on the digital signal output from the AD converter. The wireless receiver switches the output precision of the AD converter by selecting the one or more units to be operated from the plurality of units based on the received signal level.

### CROSS-REFERENCE TO RELATED APPLICATIONS

This application is based upon and claims the benefit of priority from prior Japanese Patent Application No. 2006-087707, filed Mar. 28, 2006, the entire contents of which are incorporated herein by reference.

### BACKGROUND OF THE INVENTION

1. Field of the Invention

The present invention mainly relates to a wireless receiver and, more particularly, to a wireless receiver which performs communication by using Orthogonal Frequency Division Multiplexing (OFDM) modulation having a high Peak-to-Average Power Ratio (PAPR).

2. Description of the Related Art

In recent years, the communication speed increases in wireless communication as broadband communication spreads. On the other hand, a portable wireless communication terminal with a limited supply power source is strongly required to achieve low power consumption.

One component which consumes large power in the wireless receiver is an Analog-to-Digital Converter (ADC). The AD converter to be described hereinafter is an AD converter used to convert a downconverted analog signal into a digital signal in the wireless communication terminal.

In high-speed wireless communication which requires a broad band, the AD converter needs to have a higher-level specification. For example, in a wireless LAN (WLAN) based on the IEEE802.11a which uses a 20-MHz band per channel, an AD converter capable of sampling at a frequency of 40 MHz is required. Also, in the wireless LAN based on the IEEE802.11a, Orthogonal Frequency Division Multiplexing (OFDM) is used as a signal modulation method. Therefore, Peak-to-Average Power Ratio (PAPR) is very high. Accordingly, the AD converter having a broad dynamic range is required, and, as will be described later, the AD converter actually has a 9- or 10-bit precision (e.g., see J. Thomson et al., “An integrated 802.11a Baseband and MAC Processor,” ISSCC Digest of Papers, vol. 45, pp. 126-127, February. 2002., and T. Fujisawa et al., “A Single-Chip 802.11a MAC/PHY with a 32b RISC Processor,” ISSCC Digest of Papers, vol. 48, pp. 144-145, 483, February. 2003.).

When making evaluation under an ideal condition based on the IEEE802.11a, upon using the AD converter in 7-bit or more precision, quantization noise poses no problem, and the Packet Error Rate versus Carrier-to-Noise Ratio (CNR-PER) characteristic hardly changes.

However, actually, a signal mixes in from an adjacent channel, or the characteristic varies due to analog parts (especially, an amplifier used to adjust a signal level and the like) in the wireless receiver. Hence, the amplitude of a signal cannot be accurately adjusted to a predetermined level. It is also difficult for the AD converter to maintain a uniform characteristic in the entire frequency band of an input signal. Generally, as an input signal frequency increases, the output error of the AD converter tends to increase.

Since the wireless receiver cannot predict the strength of a wireless signal which reaches an antenna, i.e., a received signal level, a variable gain amplifier must adjust the signal level. More specifically, a Received Signal Strength Indicator (RSSI) detector measures the strength of a signal output from the variable gain amplifier, and feeds back the measurement value to the variable gain amplifier to adjust the signal strength to a desired level.

Actually, upon occurrence of a signal leakage from an adjacent channel, which is not suppressed by a filter, the RSSI detector undesirably calculates a wrong value upon recognizing that the strength of a desired signal is larger than an actual value. When feeding back the wrong value to the variable gain amplifier, the output signal level of the variable gain amplifier becomes too low.

In the wireless LAN which needs to perform gain control for each packet, the measurement time for gain control is limited to very short, i.e., about 10 μs at the head of a packet. Accordingly, the signal levels may shift by the signal leakage from the adjacent channel, or the characteristic variation due to the analog elements. To cope with this problem, actually, the bit width of the AD converter needs to have a margin of several bits, so that the quantization noise caused by the AD converter poses no problem even if the signal levels shift.

In consideration of this situation, the output precision of the AD converter needs to have a margin of 2 or 3 bits, and the AD converter used in the wireless LAN device based on the IEEE802.11a needs to have a 9- or 10-bit precision, actually.

Such high-performance AD converter has very large power consumption, e.g., a power of several tens of mW is required for each AD converter which has a 10-bit precision and 40M (sampling/sec). Generally, since quadrature demodulation is performed in an analog unit of the receiver, two AD converters are required, and these AD converters consume large power for the receiver.

More specifically, in a standby time, since components other than a frame detection component in a BaseBand (B/B) unit need not be operated, power consumption can be suppressed by clock gating or power gating. Accordingly, the AD converter consumes most of the power. Generally, a standby process occupies most of the communication time, and it is an important challenge for a wireless communication system required to achieve low power consumption to decrease power consumption of the AD converter which consumes large power during the standby time.

### BRIEF SUMMARY OF THE INVENTION

According to a first aspect of the present invention, there is provided a wireless receiver comprising: an AD converter which includes a plurality of units for converting a received analog signal into a digital signal, and is configured to switch an output precision by selecting one or more units to be operated from said plurality of units; and a received signal level calculator which is connected to the AD converter, and is configured to calculate a received signal level based on the digital signal output from the AD converter, wherein the output precision of the AD converter is switched by selecting the one or more units to be operated from said plurality of units based on the received signal level.

According to a second aspect of the present invention, there is provided a wireless receiver comprising: two AD converters each of which includes a plurality of units for converting an in-phase component and a quadrature component of a received analog signal into a digital signal, and is configured to switch an output precision by selecting one or more units to be operated from said plurality of units; and a received signal level calculator which is connected to the AD converter, and is configured to calculate a received signal level based on the digital signal output from the AD converter, wherein the output precision of the AD converter is switched by selecting the one or more units to be operated from said plurality of units based on the received signal level.

### BRIEF DESCRIPTION OF THE SEVERAL VIEWS OF THE DRAWING

FIG. 1 is a view showing the basic arrangement of a wireless receiver according to the first to third embodiments of the present invention;

FIG. 2 is a view showing the arrangement of a pipeline-type AD converter in the wireless receiver according to the first embodiment of the present invention;

FIG. 3 is a view showing the arrangement of a stage of the pipeline-type AD converter according to the first embodiment of the present invention;

FIG. 4 is a view showing the arrangement of a flash-type AD converter in a wireless receiver according to the second embodiment of the present invention;

FIG. 5 is a block diagram showing the conceptual arrangement of the flash-type AD converter in the wireless receiver according to the second embodiment of the present invention;

FIG. 6 is a graph showing the relationship between an input value of the flash-type AD converter and a bit precision of an output value corresponding to the input value according to the second embodiment of the present invention;

FIG. 7 is a graph showing the relationship between an input value and an output bit precision obtained by thinning out the operations of comparators in the flash-type AD converter according to the second embodiment of the present invention;

FIG. 8 is another graph showing the relationship between an input value and an output bit precision obtained by thinning out the operations of the comparators in the flash-type AD converter according to the second embodiment of the present invention;

FIG. 9 is a view showing the arrangement of a flash-type nonlinear AD converter in a wireless receiver according to the third embodiment of the present invention;

FIG. 10 is a graph showing comparison of Carrier-to-Noise Ratio to Packet Error Rate (CNR-PER) characteristics when the output precision of the AD converter changes in an Additive White Gaussian Noise (AWGN) environment;

FIG. 11 is a graph showing comparison of the Carrier-to-Noise Ratio to Packet Error Rate (CNR-PER) characteristics when the output precision of the AD converter changes in a multipath (ETSI-A model) environment;

FIG. 12 is a graph showing the relationship between an input value of the (linear) AD converter having a 9-bit output precision, and a bit precision of an output value corresponding to the input value;

FIG. 13 is a graph showing the relationship between an input value of the AD converter, and an output bit precision required for ensuring an effective bit precision of 7 bits;

FIG. 14 is a graph showing the relationship between an input value of the nonlinear AD converter and a bit precision of an output value corresponding to the input value according to the third embodiment of the present invention;

FIG. 15 is a view showing intervals between the output levels of the nonlinear AD converter according to the third embodiment of the present invention;

FIG. 16 is a graph showing the relationship between the input analog signal of the nonlinear AD converter, and an output code according to the third embodiment of the present invention;

FIG. 17 is a graph showing the relationship between an input value and an output bit precision obtained by thinning out the operations of comparators in the nonlinear AD converter according to the third embodiment of the present invention; and

FIG. 18 is a view showing the basic arrangement of a wireless receiver according to the fourth embodiment of the present invention.

### DETAILED DESCRIPTION OF THE INVENTION

Embodiments of the present invention will be described below with reference to the accompanying drawing.

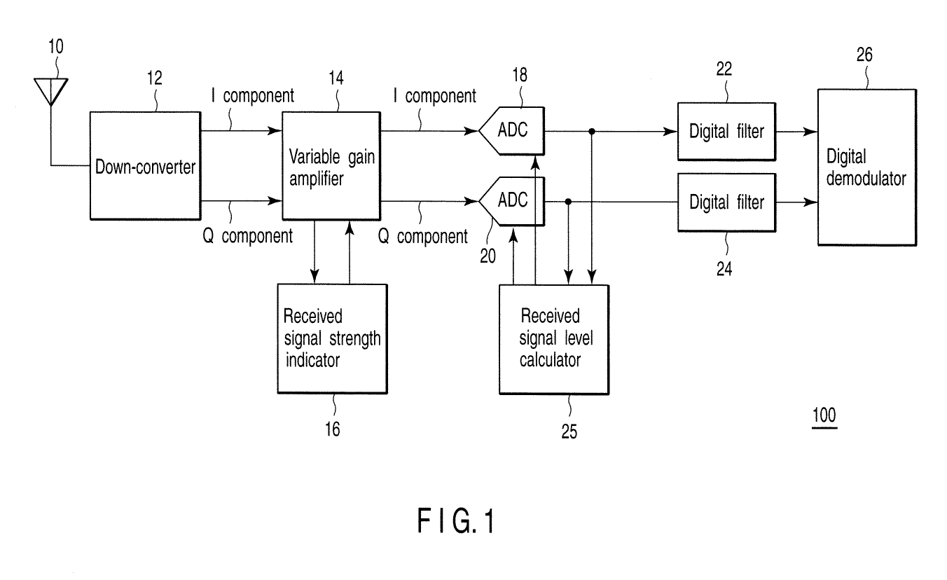

FIG. 1 shows the basic arrangement of a wireless receiver 100 according to the first to third embodiments of the present invention.

The wireless receiver 100 includes an antenna 10, a down-converter 12, a variable gain amplifier 14, a Received Signal Strength Indicator (RSSI) detector 16, an AD converter 20 and digital filter 24 for an in-phase (I) component signal, an AD converter 20 and digital filter 24 for a quadrature (Q) component signal, a received signal level calculator 25, and a digital demodulator 26.

The operation of the wireless receiver 100 will be described below.

For example, the antenna 10 receives an OFDM-modulated signal, and the down-converter 12 which performs frequency conversion down-converts the received signal into a baseband signal. At the same time, the received signal undergoes quadrature demodulation, and divided into the in-phase and quadrature component signals. The received signal strength indicator detector 16 measures the strength of a signal output from the variable gain amplifier 14, and feeds back the measurement value as the received signal strength to the variable gain amplifier 14. The variable gain amplifier 14 performs variable gain control to change a gain so that the signal strength is adjusted to a desired level based on the received signal strength.

The AD converters 18 and 20 respectively convert the in-phase and quadrature component signals into digital signals. After that, the digital filters 22 and 24 remove interference components such as signals from adjacent channels. Output signals of the digital filters 22 and 24 are input to the digital demodulator 26, and demodulated by digital signal processing. Although not shown, an analog filter or the like may be arranged on the front and rear sides of the down-converter 12 in FIG. 1, as needed.

The received signal level calculator 25 is connected to the output terminals of the AD converters 18 and 20 to calculate the received signal levels based on the digital signals respectively output from the AD converters 18 and 20. The received signal level may be the strength value of the digital signal output from each of the AD converters 18 and 20. However, in order to implement stable control, the received signal level may be calculated as an average value for each packet, or average value for each group of packets based on the output digital signal strength.

The AD converters 18 and 20 each incorporate a plurality of units used to convert analog signals which have undergone quadrature demodulation into digital signals. Upon selecting a unit to be operated from the plurality of units, the output precision can be switched.

The AD converters 18 and 20 receive the received signal level values calculated by the received signal level calculator 25. Based on the received signal level value, each of the AD converters 18 and 20 selects a unit to be operated from the plurality of units included in it.

That is, according to the embodiments, the output precision of each of the AD converters 18 and 20 is not switched based on the Received Signal Strength Indicator (RSSI) measured by the received signal strength indicator detector 16. The output precision is switched based on the level of the signal output from each of the AD converters 18 and 20.

The received signal level calculator 25 calculates the received signal levels based on the digital signals output from the AD converters 18 and 20. A unit to be operated is selected from the plurality of units, such that the output precisions of the AD converters 18 and 20 become high when the received signal level is low, and the output precisions of the AD converters 18 and 20 become low when the received signal level is high. With this operation, the output precision (effective bit width) of the AD converter can be switched.

### First Embodiment

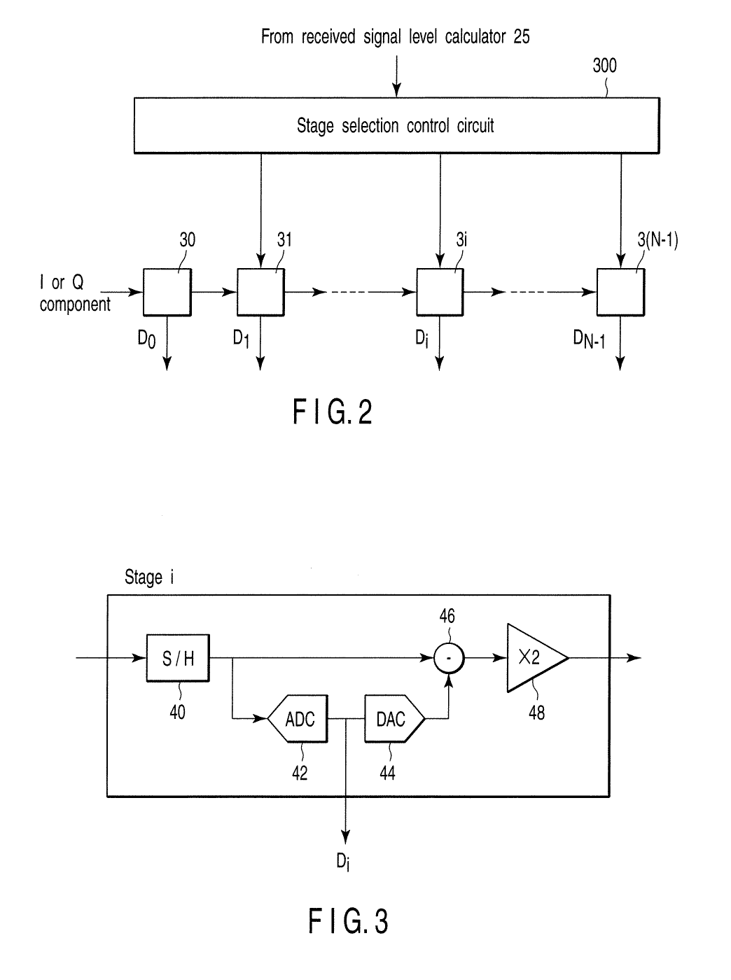

FIG. 2 shows the arrangement of each of AD converters 18 and 20 in a wireless receiver 100 according to the first embodiment of the present invention. In this embodiment, each of the AD converters 18 and 20 shown in FIG. 1 comprises a pipeline-type AD converter shown in FIG. 2.

Referring to FIG. 2, the pipeline-type AD converter has an arrangement in which a plurality of (N) stages 30 to 3(N-1) are connected in a pipeline manner. That is, a plurality of stages serving as basic circuit blocks having the same function are arranged by the output bit count, and the signal input to the stage 30 is sequentially processed by pipeline processing for each stage.

That is, the stage 30 to which the input terminal is directly connected decides the Most Significant Bit (MSB), and the stage 3(N-1) decides the Least Significant Bit (LSB). These plurality of stages correspond to the above-described units to be selected.

Referring to FIG. 3, each stage includes an S/H (Sample and Hold) circuit 40, AD converter 42, DA converter 44, subtractor 46, and amplifier 48. The S/H circuit 40 samples the input data in synchronism with a clock (not shown), and holds the sampled data. The AD converter (or comparator) 42 converts the data held by the S/H circuit 40 in comparison with a reference voltage, and determines an output bit Di for each stage.

The DA converter 44 converts the output digital data Di determined by the AD converter 42 into analog data. The subtractor 46 calculates a difference between the data held by the S/H circuit 40 and the data output from the DA converter 44. The amplifier 48 amplifies the output from the subtractor 46 such that the amplitude becomes twice, and outputs it as a residual signal to the next stage. The larger the number of stages becomes, the more precise AD conversion result becomes.

Referring to FIG. 2, the AD converters 18 and 20 each have a stage selection control circuit 300. The stage selection control circuit 300 transmits an operation control signal to a stage to be operated based on the received signal level supplied from a received signal level calculator 25 shown in FIG. 1, thereby selecting the stage. With this operation, each of the AD converters 18 and 20 can switch the output precision.

More specifically, when the received signal level is low, all the plurality of stages shown in FIG. 2 are operated to perform precise AD conversion. On the other hand, when the received signal level is high, the operations of all the stages arranged on the right side of the stage 3i are stopped to degrade the AD conversion precision. Accordingly, when the received signal level is high, the power consumption for the S/H circuit 40, AD converter (comparator) 42, DA converter 44, subtractor 46, and amplifier 48 included in the stage conventionally operated to obtain unnecessarily precise AD conversion result can be reduced.

### Second Embodiment

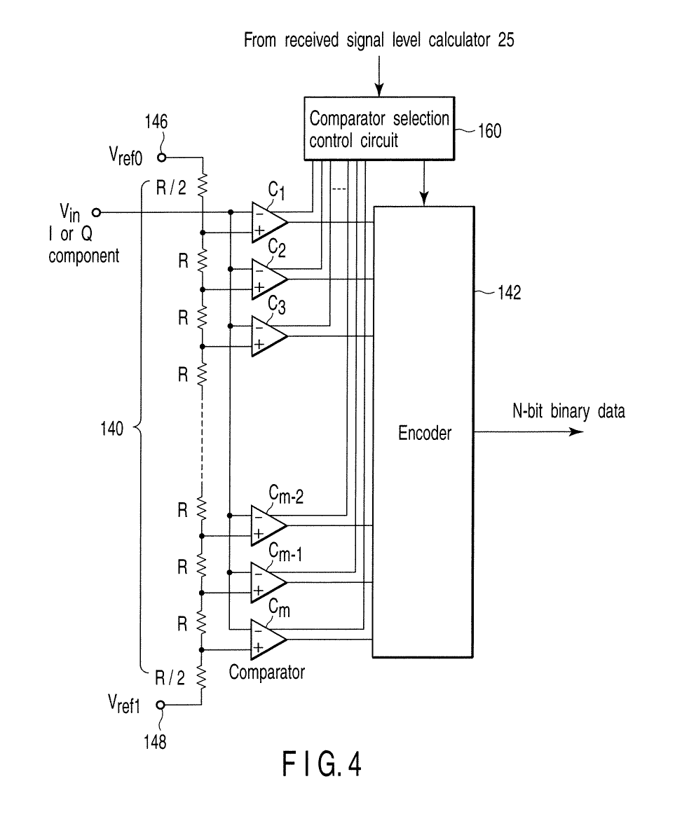

FIG. 4 shows the arrangement of each of AD converters 18 and 20 in a wireless receiver 100 according to the second embodiment of the present invention. In this embodiment, each of the AD converters 18 and 20 shown in FIG. 1 comprises a flash-type AD converter shown in FIG. 4.

Referring to FIG. 4, the flash-type AD converter in this embodiment includes a comparator selection control circuit 160 in addition to three basic elements, i.e., a resistor ladder 140, comparators C₁ to Cₘ serving as comparing devices, and an encoder 142.

Based on the resistance ratio of the resistors included in the resistor ladder 140, the resistor ladder 140 divides, into m+1(=2^{N}) sections, the potential between a reference voltage V_{ref0} which is supplied from a first power source 146 connected to one end of the resistor ladder 140, and a reference voltage V_{ref1} which is lower than the reference voltage V_{ref0} and supplied from a second power source 148 connected to the other end of the resistor ladder 140. In this case, the resistor ladder 140 includes the resistors each having the same resistance value R such that the output level intervals become uniform as in the general flash-type AD converter.

The comparators C₁ to Cₘ respectively compare m (=2^{N}−1) voltages generated by the resistor ladder 140 and input voltages Vᵢₙ. The encoder 142 converts the comparison results obtained by the comparators C₁ to Cₘ into N-bit binary data. In the conventional flash-type AD converter, all the comparators C₁ to Cₘ are operated in AD conversion.

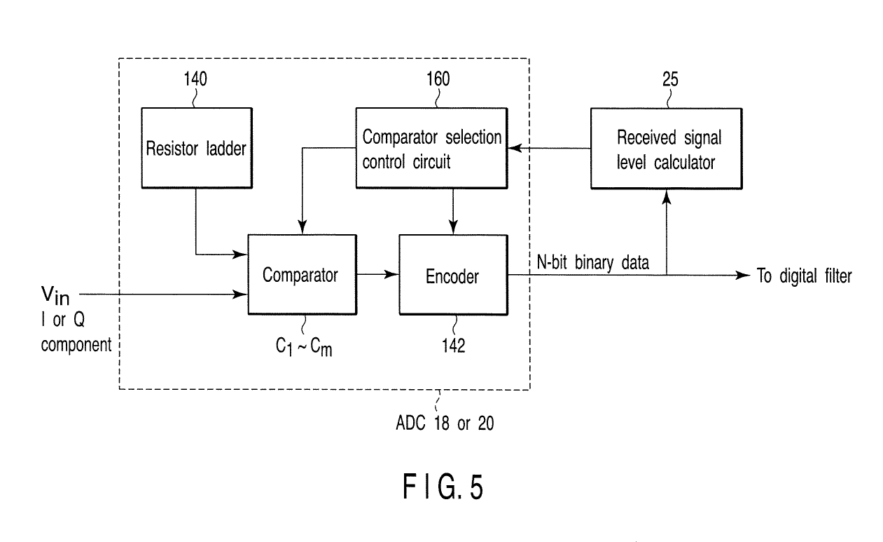

In the second embodiment of the present invention, the flash-type AD converter further includes the comparator selection control circuit 160 to transmit an operation control signal to the comparators C₁ to Cₘ based on the received signal level supplied from a received signal level calculator 25 shown in FIG. 1. FIG. 5 is a block diagram conceptually showing this state. In this embodiment, each comparator corresponds to each unit to be selected as described above.

As has been described above, when the comparator to be operated can be selected in accordance with the received signal level, low power consumption can be achieved as in the first embodiment of the present invention. That is, the output bit precision of the AD converters 18 and 20 changes in accordance with the received signal level calculated by the received signal level calculator 25.

More specifically, when the received signal level is low, all the comparators C₁ to Cₘ are operated to set the number of output levels of the AD converters 18 and 20 equal to the number of levels of the resistor ladder shown in FIG. 4, thereby maximizing the output precision.

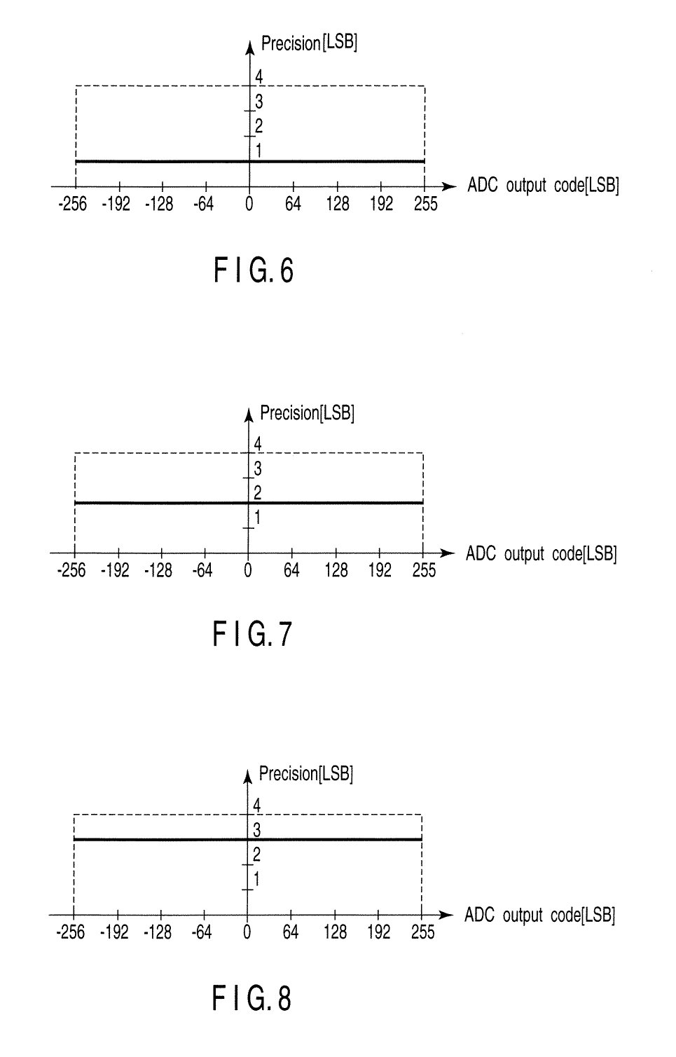

In this case, FIG. 6 shows the relationship between the input value of the flash-type AD converter having the N=9 (bit) output precision, and the intervals between the levels (bit precision) of the output value (and its approximate values) corresponding to the input value. Note that the abscissa which plots the input value indicates a converted value obtained when a 9-bit AD converter converts the analog input value into a 9-bit precision digital value. The ordinate represents the interval between the levels of the output value corresponding to the input value, i.e., the output bit precision, by the unit of a bit width of the 9-bit precision.

Accordingly, the solid line in FIG. 6 represents that the AD converter having a 9-bit output precision performs quantization (digitalization) for each value obtained by dividing the input dynamic range at regular intervals, i.e., uniformly dividing the input dynamic range into nine bits.

However, in this embodiment, when the received signal level is high, the operations of the comparators C₁ to Cₘ are thinned out to ½ or ⅓. With this operation, the output precision of the AD converter degrades as shown in FIGS. 7 and 8. With this operation, power consumption for the AD converter can be suppressed by power consumption for the non-operated comparators.

In this case, since the encoding method of the encoder 142 need change in accordance with the selected comparators, the comparator selection control circuit 160 can also transmit a control signal to the encoder 142.

It is generally known that an OFDM-converted signal has a broad signal strength distribution and very high Peak-to-Average Power Ratio (PAPR). In order to adequately avoid clipping for a signal having a large amplitude, an AD converter having a broad dynamic range is required. However, it is unnecessary to increase the output precision in accordance with the broad dynamic rage.

That is, if the output precision of the AD converter has a margin in consideration of the shift of a signal level or the like, when the variable gain amplifier can accurately adjust the signal level, the interval between the output levels of the AD converter becomes excessively small, and the lower bit of an output result becomes unnecessary information.

According to the first and second embodiments of the present invention, a hardware unit included in the AD converter is selectively operated in accordance with the received signal level based on the digital signal output from the AD converter, thereby avoiding unnecessarily precise quantization. With this operation, the unnecessary power consumption for the AD converter can be avoided, and a wireless receiver with low power consumption can be implemented. According to these embodiments of the present invention, in the receiver of an OFDM-modulated wireless signal having a very high Peak-to-Average Power Ratio (PAPR), the effectiveness is especially enhanced.

### Third Embodiment

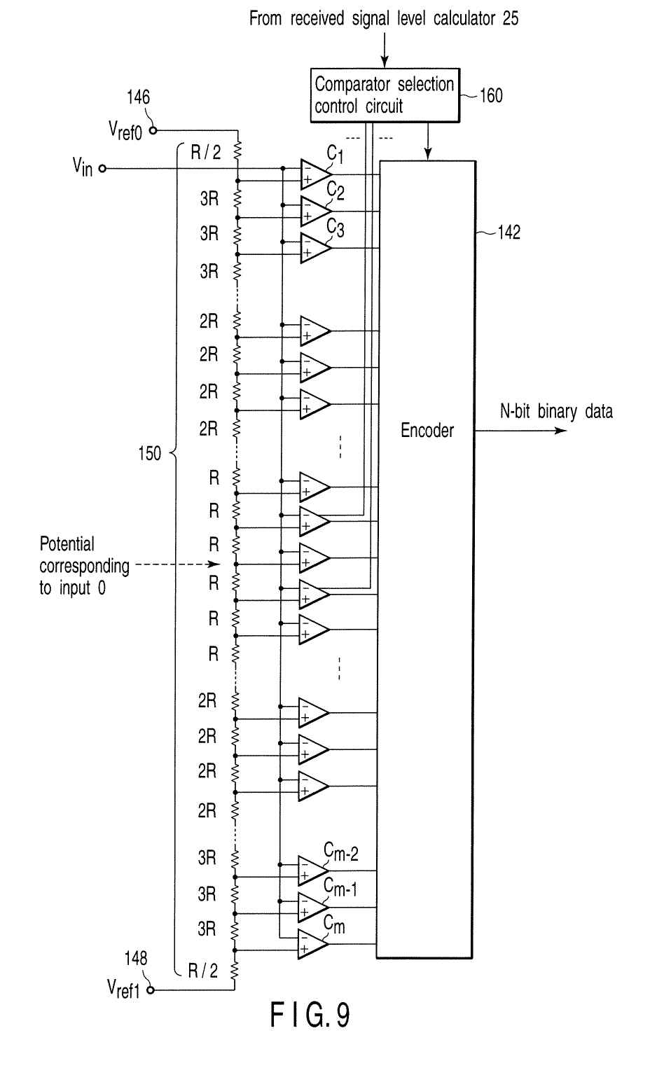

FIG. 9 shows the arrangement of each of AD converters 18 and 20 in a wireless receiver 100 according to the third embodiment of the present invention. In this embodiment, the AD converters 18 and 20 as shown in FIG. 1 each comprise a flash-type nonlinear AD converter as shown in FIG. 9.

The arrangement in FIG. 9 is largely different from that in FIG. 4 according to the second embodiment in that each of the AD converters 18 and 20 is a nonlinear AD converter which is configured such that the output value levels has a small interval (high precision) when the absolute value of the input analog signal is small, and the output value levels have a large interval (low precision) when the absolute value of the input analog signal is large. In other words, the difference between the levels of the input analog signals converted into the adjacent digital signals does not change or becomes larger as the level of the input analog signal increases.

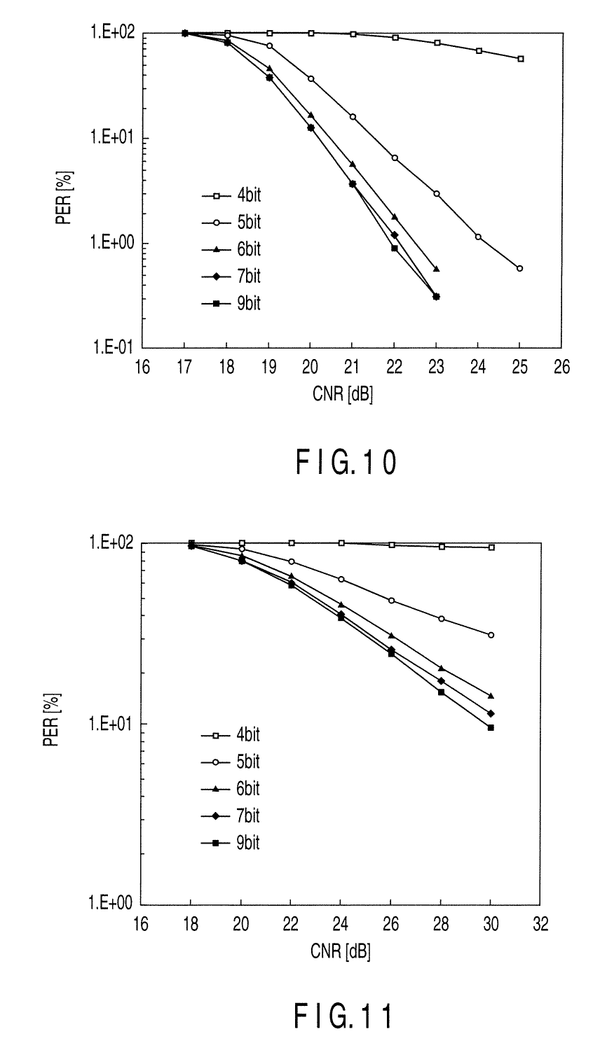

FIGS. 10 and 11 respectively show results of comparing Carrier-to-Noise Ratio to Packet Error Rate (NCR-PER) characteristics obtained when changing the output precision (bit width) of the AD converter in an Additive White Gaussian Noise (AWGN) environment and a multipath environment (assuming an ETSI-A model) based on the IEEE802.11a as the standard specification of a wireless LAN device. Note that the transmission speed is evaluated as 54 Mbps, and a packet length is evaluated as 1,000 bytes.

Referring to FIGS. 10 and 11, when using the AD converter in 7-bit or more precision under an ideal condition, quantization noise does not pose a problem, and the CNR-PER characteristic hardly changes. However, actually, a (linear) AD converter with a margin to have 9- or 10-bit precision is conventionally used in consideration of non-ideal factors such as the signal leakage from an adjacent channel and the nonuniformity of the analog element characteristics.

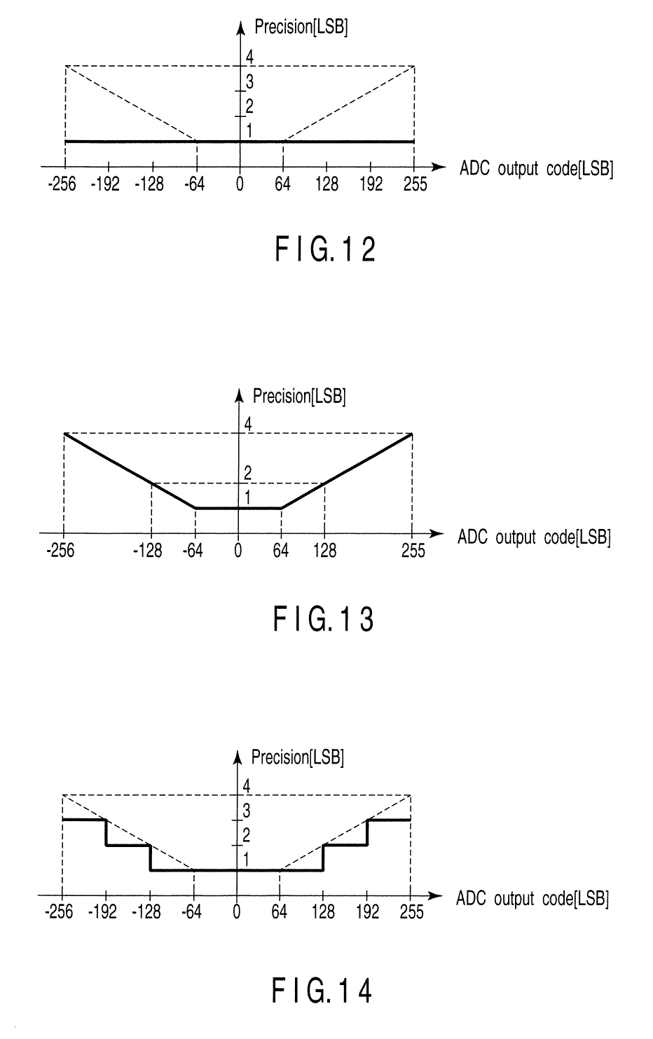

In FIG. 12, a solid line represents the relationship between the input value of the (linear) AD converter having the 9-bit output precision, and the interval between the output levels (output bit precision) corresponding to the input value. In this case, the units of the abscissa and ordinate are the same as those in FIGS. 6 to 8.

As described above, in the wireless LAN based on the IEEE802.11a, when an AD converter has a 7-bit or more output levels, the reception performance hardly changes. Therefore, if the input values of −128 to +128 [LSB] are used when the received signal level can be accurately adjusted, the AD converter with a precision higher than that represented by the solid line (the lower side of the solid line) in FIG. 13 can ensure an effective bit precision of 7 bits or more although the amplitude shifts by ±6 dB (=2 bits width of the precision of the AD converter).

Accordingly, even when using the nonlinear AD converter having a precision represented by a step-shaped solid line shown in FIG. 14, a wireless receiver with the reception performance equal to that of the conventional 9-bit AD converter shown in FIG. 12 can be implemented.

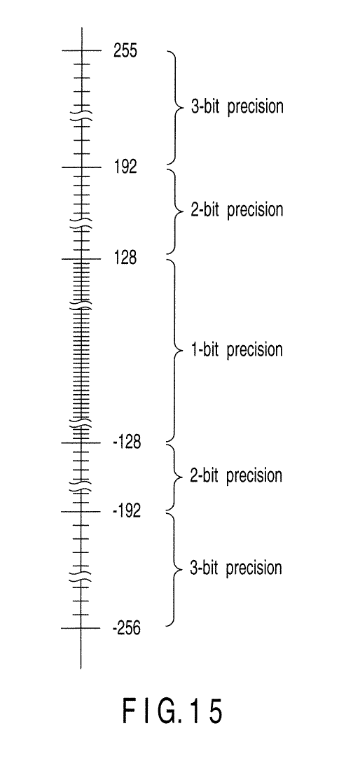

FIG. 15 shows the precision of the output tone level of the nonlinear AD converter shown in FIG. 14. In FIG. 15, as the input analog signal level increases, a quantization unit step-functionally increases, and the precision degrades. Referring to FIG. 15, the ordinate is in the unit represented by the value obtained by (almost) linearly converting the analog input value into the digital value having the 9-bit precision by using the 9-bit (linear) AD converter, as the abscissas shown in FIGS. 12 to 14.

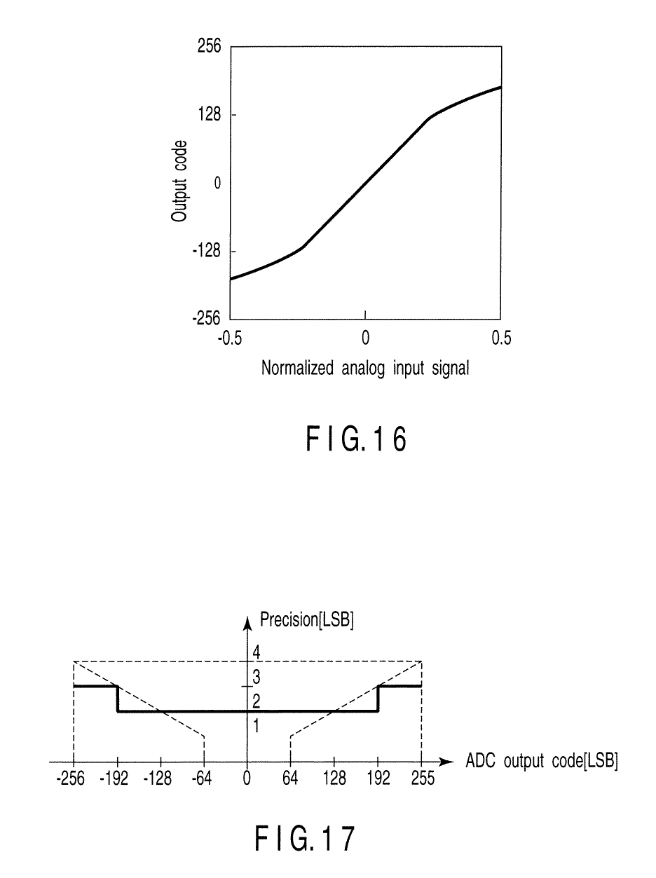

FIG. 16 shows the nonlinear relationship between the input analog signal and output code of the nonlinear AD converter shown in FIG. 14. Referring to FIG. 16, the input analog signal in the entire dynamic range can be expressed by the output code having 364 levels in total.

That is, when using the conventional 9-bit (linear) AD converter, the number of levels of the output code must be 512. However, when using the nonlinear AD converter according to this embodiment of the present invention, the number of levels of the output code can be reduced to 364, and the wireless receiver having a performance equal to that of the conventional AD converter can be implemented. As described above, a nonlinear AD converter which has no unnecessarily redundant output levels can be used to downsize the hardware and reduce the power consumption of the AD converter.

A resistor ladder 150 shown in FIG. 9 implements the nonlinear AD converter having the precision represented by the step-shaped solid line shown in FIG. 14. For the potentials corresponding to the input values of −128 to +128 including 0 shown in FIG. 14, the resistor included in the resistor ladder 150 which generates the potentials compared by the comparators has a resistance value R to implement 1-bit width level interval.

For the potentials corresponding to the successive input values of 128 to 192 and −128 to −192, the resistance value becomes 2R or 3R which is twice or three times the resistance value R toward first and second power sources 146 and 148, thereby implementing the stepped-shaped precision shown in FIGS. 14 and 15.

On the other hand, a conventional resistor ladder 140 shown in FIG. 4 includes only resistors each having a resistance value R corresponding to the minimum level width of the resistor ladder 150. Hence, when reference voltages V_{ref0} and V_{ref1} at the two ends of the resistor ladder 140 are the same as those in FIG. 9, the number of comparators, the scale of the hardware of the encoder, and the number of resistors can be decreased by using the flash-type nonlinear AD converter shown in FIG. 9. According to this embodiment, the wireless receiver with a smaller hardware which can achieve lower power consumption, and maintain the same reception performance in comparison with the wireless receiver using the flash-type AD converter having the conventional resistor ladder, can be implemented.

Furthermore, in this embodiment, when the output level of the AD converter is high, the operations of the unnecessary comparators stop to further decrease the power consumption of the AD converter.

For example, when the received signal level based on the output from the AD converter is low, the output bit precision is set as shown in FIG. 14. When the received signal level is high, the output bit precision is set as shown in FIG. 17. When the received signal level is high, a comparator selection control circuit 160 stops the operations of the comparators corresponding to the input values of −128 to +128 in FIG. 14 every other, the comparators comparing the input values and the potentials generated by the resistors each having the resistance value R in the resistor ladder 150 shown in FIG. 9. With this operation, when the received signal level is high, the unnecessary bit precision degrades to obtain the output bit precision as shown in FIG. 17. As a result, the power consumption of the comparators can be suppressed.

As described above, when using the nonlinear AD converter according to this embodiment as shown in FIG. 9, the number of comparators can be decreased to reduce the circuit scale and power consumption. Additionally, the operations of the comparators used to obtain the unnecessary output precision can be stopped in accordance with the output level of the AD converter. Hence, the wireless receiver can reduce the hardware scale and power consumption while maintaining the reception performance equal to that of the conventional AD converter.

In this embodiment of the present invention, while maintaining the reception performance of the wireless receiver, the hardware scale and power consumption of the wireless receiver can be reduced at the same time. According to this embodiment of the present invention, in the receiver of the OFDM-modulated wireless signal having very large Peak-to-Average Power Ratio (PAPR), the effectiveness is especially enhanced.

### Fourth Embodiment

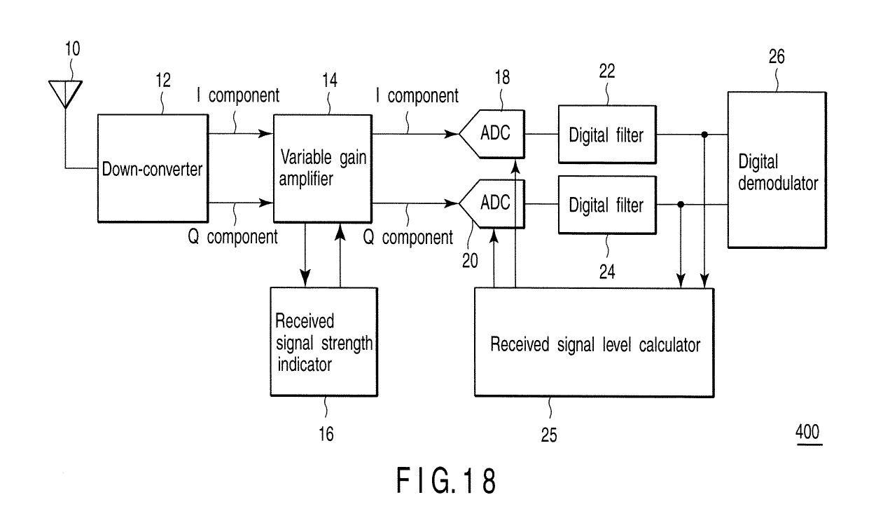

FIG. 18 shows the basic arrangement of a wireless receiver 400 according to the fourth embodiment of the present invention.

Referring to FIG. 1, a received signal level calculator 25 is directly connected to the output terminals of AD converters 18 and 20. However, the received signal level calculator 25 may be connected to the output terminals of digital filters 22 and 24 as shown in FIG. 18.

With this arrangement, since a received signal level can be calculated based on a digital signal from which an interference component such as a signal from an adjacent channel is already removed by the digital filters 22 and 24, it is expected to appropriately control the AD conversion precision of the AD converters 18 and 20. In this arrangement, of course, the AD converter described in the first to third embodiments can also be used as each of the AD converters 18 and 20.

One aspect of the present invention can provide the wireless receiver having the AD converter which achieves a small circuit scale and low power consumption mainly used for communication and the like of a signal modulated by Orthogonal Frequency Division Multiplexing (OFDM) modulation having a high Peak-to-Average Power Ratio (PAPR).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless receiver comprising:
an AD converter which includes a plurality of units for converting a received analog signal into a digital signal, and is configured to switch an output precision by selecting one or more units to be operated from said plurality of units; and
a received signal level calculator which is connected to the AD converter, and is configured to calculate a received signal level based on the digital signal output from the AD converter,
wherein the output precision of the AD converter is switched by selecting the one or more units to be operated from said plurality of units based on the received signal level.

2. A device according to claim 1, wherein the AD converter is a pipeline-type AD converter which includes said plurality of units serving as a plurality of stages for sequentially processing the input signal, and
the output precision of the AD converter is switched by selecting one or more stages to be operated from said plurality of stages based on the received signal level.

3. A device according to claim 2, wherein each of the stages includes a Sample and Hold circuit, an AD converter, a DA converter, a subtractor, and an amplifier.

4. A device according to claim 1, wherein the AD converter is a flash-type AD converter which includes said plurality of units serving as a plurality of comparing devices for parallelly processing the input signal, and
the output precision of the AD converter is switched by selecting one or more comparing devices to be operated from said plurality of comparing devices based on the received signal level.

5. A device according to claim 4, wherein the flash-type AD converter includes a first power source, a second power source which supplies a voltage lower than a voltage supplied by the first power source, and a resistor ladder which includes a plurality of resistors series-connected between the first power source and the second power source and supplies, to each of said plurality of comparing devices, a potential to be compared with the input signal.

6. A device according to claim 5, wherein the resistor ladder includes a plurality of resistors which are series-connected and have the same resistance value.

7. A device according to claim 5, wherein the resistor ladder includes a plurality of first resistors which are series-connected and have a first resistance value, and a plurality of second resistors which are series-connected to both ends of the plurality of first resistors and have the second resistance value larger than the first resistance value.

8. A device according to claim 1, wherein the received signal level is a value obtained by averaging a strength of a digital signal output from the AD converter in a predetermined period.

9. A device according to claim 1, wherein the analog signal is an OFDM-modulated signal.

10. A device according to claim 1, further comprising a digital filter to which a digital signal from the AD converter is input, wherein the received signal level calculator calculates a received signal level based on a digital signal output from the digital filter.

11. A wireless receiver comprising:
two AD converters each of which includes a plurality of units for converting an in-phase component and a quadrature component of a received analog signal into a digital signal, and is configured to switch an output precision by selecting one or more units to be operated from said plurality of units; and
a received signal level calculator which is connected to the AD converter, and is configured to calculate a received signal level based on the digital signal output from the AD converter,
wherein the output precision of the AD converter is switched by selecting the one or more units to be operated from said plurality of units based on the received signal level.

12. A device according to claim 11, wherein the AD converter is a pipeline-type AD converter which includes said plurality of units serving as a plurality of stages for sequentially processing the input signal, and
the output precision of the AD converter is switched by selecting one or more stages to be operated from said plurality of stages based on the received signal level.

13. A device according to claim 12, wherein each of the stages includes a Sample and Hold circuit, an AD converter, a DA converter, a subtractor, and an amplifier.

14. A device according to claim 11, wherein the AD converter is a flash-type AD converter which includes said plurality of units serving as a plurality of comparing devices for parallelly processing the input signal, and
the output precision of the AD converter is switched by selecting one or more comparing devices to be operated from said plurality of comparing devices based on the received signal level.

15. A device according to claim 14, wherein the flash-type AD converter includes a first power source, a second power source which supplies a voltage lower than a voltage supplied by the first power source, and a resistor ladder which includes a plurality of resistors series-connected between the first power source and the second power source and supplies, to each of said plurality of comparing devices, a potential to be compared with the input signal.

16. A device according to claim 15, wherein the resistor ladder includes a plurality of resistors which are series-connected and have the same resistance value.

17. A device according to claim 15, wherein the resistor ladder includes a plurality of first resistors which are series-connected and have a first resistance value, and a plurality of second resistors which are series-connected to both ends of the plurality of first resistors and have the second resistance value larger than the first resistance value.

18. A device according to claim 11, wherein the received signal level is a value obtained by averaging a strength of a digital signal output from the AD converter in a predetermined period.

19. A device according to claim 11, wherein the analog signal is an OFDM-modulated signal.

20. A device according to claim 11, further comprising two digital filters to which digital signals from the AD converters are respectively input, wherein the received signal level calculator calculates a received signal level based on a digital signal output from the digital filter.
